(19) United States
(12) Patent Application Publication
(10) Pub. No.: US 2026/0358156 A1
(43) Pub. Date: Nov. 12, 2026

(54) HIGH EFFICIENCY MAGNETIC FLOWMETER WITH ENHANCED FREQUENCY RESPONSE

(71) Applicant: Micro Motion, Inc., Boulder, CO (US)

(72) Inventors: Samuel Ethan Messenger, Chaska, MN (US); Nicholas William Bond, Belle Plaine, MN (US); John Christopher Beyl, Belle Plaine, MN (US)

(21) Appl. No.: 19/421,443

(22) Filed: Dec. 16, 2025

Related U.S. Application Data
(60) Provisional application No. 63/804,143, filed on May 12, 2025.

(51) Int. Cl. G01F 1/58; G01F 1/60

(52) U.S. Cl. CPC G01F 1/586; G01F 1/60

(57) ABSTRACT

A magnetic flowmeter for measuring flow rate of a process fluid includes a flowtube arranged to receive a flow of the process fluid therethrough. A first magnetic coil arranged proximate the flowtube to applies a magnetic field to the process fluid flowing through the flowtube. A pair of electrodes electrically couple to the process fluid in the flowtube and sense a voltage induced in the process fluid related to the applied magnetic field and a flow rate of the process fluid. Flowmeter circuitry applies an electric current to the first magnetic coil and receive the voltage sensed by the pair of electrodes. A magnetic pole adjacent the first magnetic coil is arranged to direct the magnetic field into the process fluid flowing through the flowtube, the magnetic pole has a split configuration. In another aspect, the magnetic pole is formed by a plurality of metal pieces.

### CROSS-REFERENCE TO RELATED APPLICATION

The present application is based on and claims the benefit of U.S. provisional patent application Ser. No. 63/804,143, filed May 12, 2025, the content of which is hereby incorporated by reference in its entirety.

### BACKGROUND

Magnetic flowmeters (or mag meters) measure flow by application of Faraday's Law, an electromagnetic effect. The magnetic flowmeter energizes one or more coils by passing an excitation current through field windings which generates a magnetic field across an electrically isolated, conductive process flow. An electromotive force (EMF) is generated by the flowing process fluid crossing through the magnetic field; this induced voltage (potential) both across the fluid and with respect to the rest of the process fluid can readily be measured by one or more conductive electrodes that contact the flowing process fluid. Alternatively, some magnetic flowmeters employ capacitive coupling between the electrodes and the process fluids such that the potential can be measured without direct electrical connection to the process. The volumetric flow is proportional to the flow velocity and the cross-sectional area of the flowtube. As the flow velocity is directly proportional to the electrode voltage potential (EV), the electrode voltage potential (EV) is directly proportional to the induced magnetic field strength (B), and the induced magnetic field strength is assumed to be proportional to the applied magnetic field (H), which is directly linked to the magnitude of the excitation current, a direct correlation is provided between measured electrode voltage potential and indicated volumetric flow.

Magnetic flowmeters are useful in a variety of conductive and semi-conductive fluid flow measurement environments. In particular, the flow of water-based fluids, ionic solutions and other conducting fluids can all be measured using magnetic flowmeters. Thus, magnetic flowmeters can be found in water treatment facilities, beverage and hygienic food production, chemical processing, high purity pharmaceutical manufacturing, as well as hazardous and corrosive processing facilities. Magnetic flowmeters are often employed in the hydrocarbon fuel industry which sometimes employs hydraulic fracturing techniques using abrasive and corrosive slurries.

### SUMMARY

A magnetic flowmeter for measuring flow rate of a process fluid includes a flowtube arranged to receive a flow of the process fluid therethrough. A first magnetic coil arranged proximate the flowtube to applies a magnetic field to the process fluid flowing through the flowtube. A pair of electrodes electrically couple to the process fluid in the flowtube and sense a voltage induced in the process fluid related to the applied magnetic field and a flow rate of the process fluid. Flowmeter circuitry applies an electric current to the first magnetic coil and receive the voltage sensed by the pair of electrodes. A magnetic pole adjacent the first magnetic coil is arranged to direct the magnetic field into the process fluid flowing through the flowtube, the magnetic pole has a split configuration. In another aspect, the magnetic pole is formed by a plurality of metal pieces.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view showing a process control system including a magnetic flowmeter.

FIG. 2 is a block diagram of a magnetic flowmeter with which embodiments of the present invention are particularly applicable.

FIG. 3A is a perspective view of a magnetic flowmeter flowtube assembly in accordance with of the present invention.

FIGS. 3B and 3C are an enlarged perspective views of the flowtube assembly of FIG. 3A.

FIG. 4A is a perspective view of a flowmeter in accordance with another configuration.

FIGS. 4B and 4C are an enlarged perspective views of a portion of the flowmeter of FIG. 3A.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

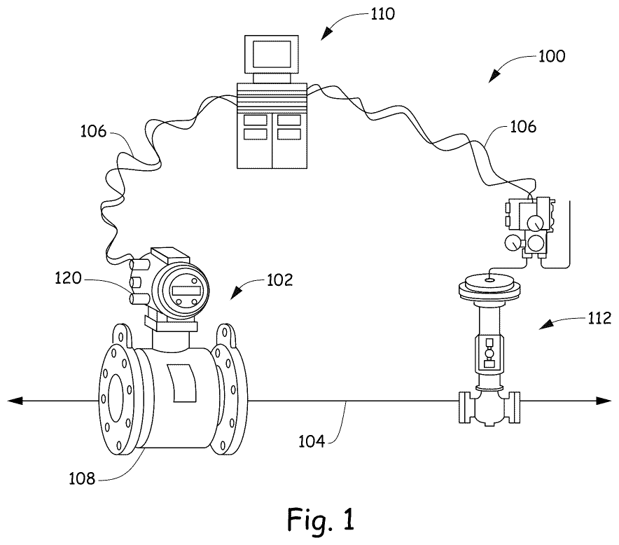

FIG. 1 illustrates a typical environment 100 for magnetic flowmeter 102. Magnetic flowmeter 102 is coupled to process piping, illustrated diagrammatically at line 104 that also couples to control valve 112. Magnetic flowmeter 102 is configured to provide a flow rate output relative to process fluid flow through piping 104 in a process. Examples of such process fluids includes slurries and liquids in chemical, pulp, pharmaceutical, water treatment and other fluid processing plants.

Magnetic flowmeter 102 includes electronics housing 120 connected to flowtube 108. Magnetic flowmeter 102 outputs are configured for transmission over long distances to a controller or indicator via process communication connection 106. In typical processing plants, communication connection 106 can be either a digital communication protocol, or an analog communication signal. The same or additional process information can be made available via wireless communication, pulse width or frequency output, or discrete input/outputs (DI/DO). System controller 110 can display flow information for a human operator as well as provide control signals over process communication connection 106 in order to control the process using control valves, such as valve 112.

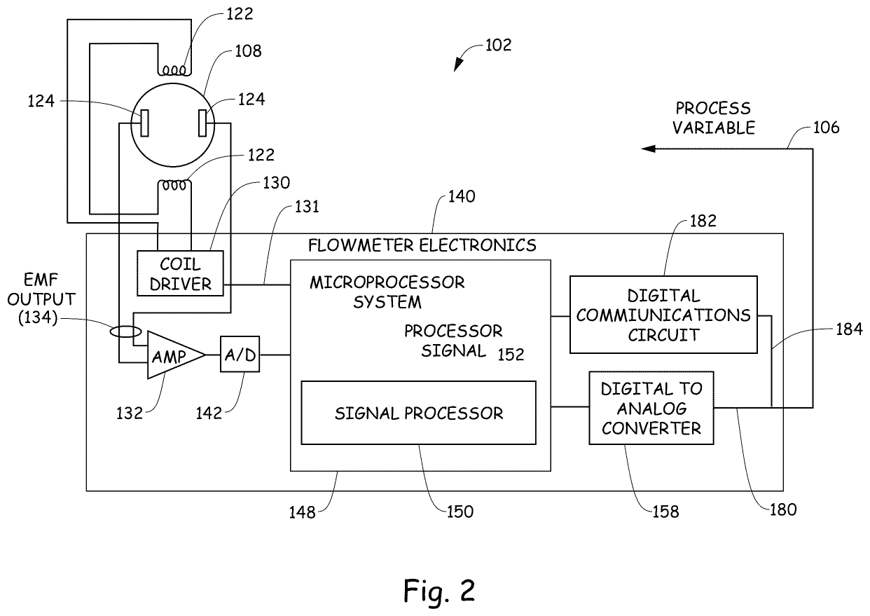

FIG. 2 is a block diagram of a magnetic flowmeter with which embodiments of the present invention are particularly applicable. Magnetic flowmeter 102 measures a flow of conductive process fluid through flowtube assembly 108. Coils 122 are configured to apply an external magnetic field in the fluid flow in response to an applied excitation current from coil driver 130. EMF sensors (electrodes) 124 electrically couple to the fluid flow and provide an EMF signal output 134 to amplifier 132 related to an EMF generated in the fluid flow due to the applied magnetic field, fluid velocity, and noise. Analog-to-digital converter 142 provides a digitized EMF signal to microprocessor system 148. A signal processor 150 is implemented in microprocessor system 148 of flowmeter electronics 140 which couples to the EMF output 134 to provide an output 152 related to fluid velocity.

Microprocessor system 148 calculates fluid flow velocity through flowtube 108 in accordance with a relationship between the EMF output 134 and flow velocity as described in an application of Faraday's Law:

$$V = \frac{E}{kBD}$$

Where E can be the signal output 152 which is related to the EMF output 134, V is the velocity of the fluid, D is the diameter of the flowtube 108, B is the strength of the induced magnetic field in the fluid, and k is a constant of proportionality. A nuance of this application of Faraday's law is that the excitation current, I, is considered directly proportional to B, the induced magnetic field. Coil driver 130 provides both the excitation current and a measurement of either the induced magnetic field or excitation current, which is important for the accuracy of the velocity measurement. The measurement of the excitation current is provided through line 131. Microprocessor system 148 uses velocity and measured magnetic field or coil current to calculate flow of the process fluid in accordance with known techniques. A digital-to-analog converter 158 coupled to microprocessor system 148 and generates an analog transmitter output 180 for coupling to communication bus 106. A digital communication circuit 182 generates a digital transmitter output 184. The analog output 180 and/or the digital output 184 can be coupled to process controllers or monitors as desired.

The accuracy of the flowmeter is related to the applied magnetic field. The coils 122 are used to produce the applied magnetic field. When an electric current is applied to a coil 122, a magnetic field will be generated which leaves one side of the coil 122, and returns to the other side of the coil. However, the shape of the magnetic field conforms very closely to the shape of the coil. If a coil 122 is place near the flowtube, very little of the magnetic field would actually enter the tube and pass through the moving fluid, which is needed to obtain a flow measurement.

In order to shape the applied magnetic field such that more of the field extends into the process fluid, metal pole pieces are used. A lower pole piece is placed closest to the flowtube and shapes the magnetic field which enters the flowtube. The magnetic field exits the flowtube and is routed around the exterior of the flowtube along a magnetic field return path.

As the magnetic field flows through a pole piece, an electrical current is generated within the metal pole piece which is known as an Eddy current. Generation of this Eddy current reduces the efficiency of the coil and reduces the strength of the magnetic field. Further, the pole pieces change the inductance of the coil 122 and make it more difficult to drive the coil with an applied current at a desired frequency.

Further, it is desirable to provide high performance flow measurements at many locations throughout an industrial process plant, including hazardous areas (explosion risk). To do this effectively, the device needs to be intrinsically safe. This requires an ultra-low power, but high performance design. However, many magnetic flowmeters typically require up to 9 watts to be driven (excited) through the coil 122 to produce magnetic field which will provide a viable flow signal at low coil drive frequencies. The large size of the magnetic coils 122 limits the overall size of the meter and available process connections in typical industry standard piping configurations. The higher power required is due to inefficiencies in the magnetics design, and the need to keep inductance low so a satisfactory coil drive frequency can be achieved with a relatively low drive voltage. The low coil drive frequency is the primary limiting factor for performance. The low frequency requirement is primarily due to long settling time and strong nonlinearities along with electromagnetic coupling, which mandate a delay before the flow sample is taken. The high power requirements can limit the installation methods of the product and require explosion proof type wiring in many plant installations.

With the present invention, a low power, high speed, high performance magnetic flowmeter is provided that can operate using 16 times less power (for example, 420-550 mW) and provide the same or better performance compared to prior configurations. As a result of the low power consumption and low voltage required to achieve high performance, the flowmeter can be installed as an intrinsically safe device. The configurations of the invention maintain high signal strength, high SNR (Signal to Noise Ratio), and the ability to operate at multiple higher frequencies with minimal change in rated accuracy. Upstream piping of only 5 diameters of line size is required to achieve rated accuracy, and the system is less sensitive to upstream obstructions.

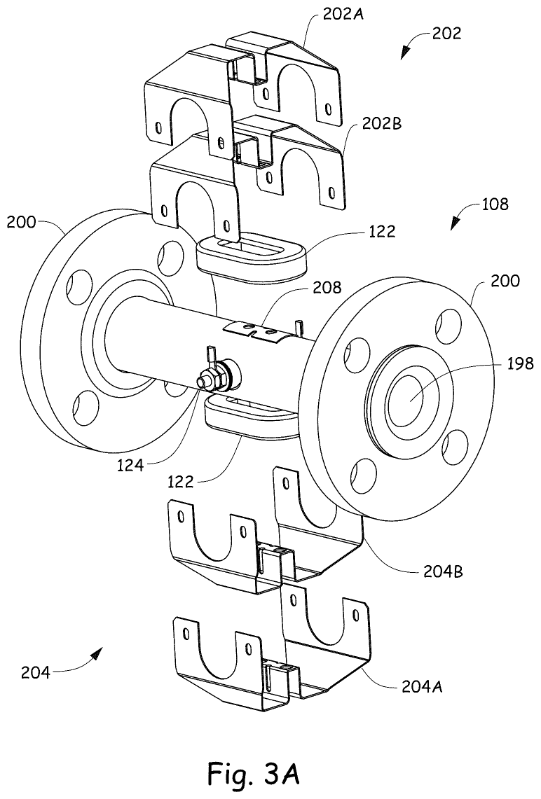

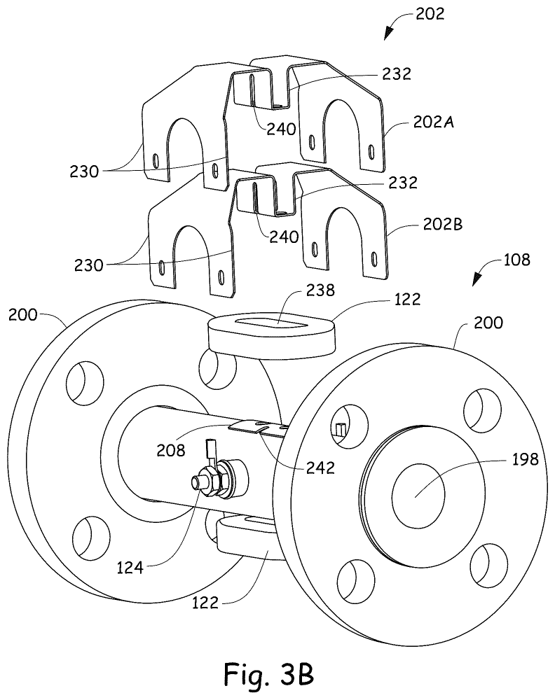

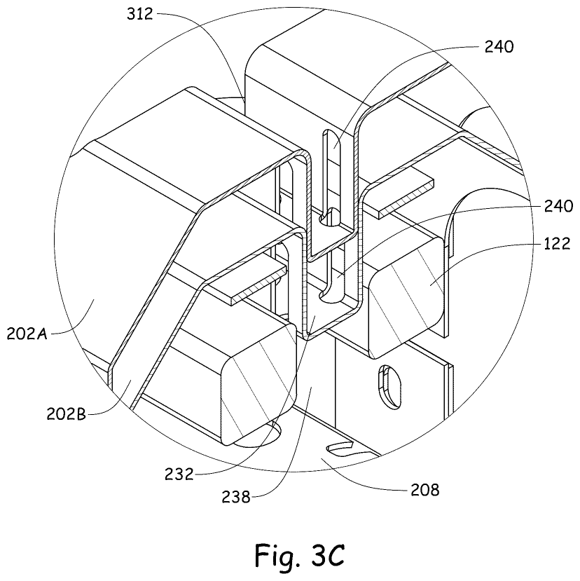

FIG. 3A is a perspective exploded view of one configuration of a magnetic flowtube and associated magnetic components in accordance with the present invention. FIG. 3A is applicable for flowtubes having smaller line sizes, for example less than 1.25 inches in diameter. In FIG. 3A flowtube 108 includes end flanges 200 for coupling to process piping thereby allowing a flow of process fluid to flow through an interior 198 of the flowtube 108. FIGS. 3B and 3C are enlarged perspective views showing the arrangement of FIG. 3A.

FIGS. 3A-C show an arrangement of an upper pole 202, lower pole 208 and coils 122. As illustrated in FIGS. 3A-C, upper pole 202 includes upper pole laminated pieces 202A and 202B. Similarly, upper pole 204 includes laminated pole pieces 204A and 204B. Coils 122 are positioned proximate flowtube 108 and positioned between upper pole 202 and lower pole 208 along with upper pole 204 and lower pole 208. A second lower pole 208 (not shown) is located on the opposite side of the flowtube 108.

As illustrated in the enlarged views of FIGS. 3B and 3C, pole 202 is a multilayer configuration formed by two individual magnetic metal (pole) pieces 202A and 202B separated by an insulating layer, for example, an insulating coating. Pole pieces 202A and 202B include legs, or magnetic return paths, 230 arranged to form a notch for placement around electrode 124 contacts. Further, pieces 202A and 202B include a central portion 232 arranged to fit within a center 238 of coil 122 and provide a magnetic path therethrough. These central portions 232 magnetically couple with lower pole 208 to provide a magnetic circuit directing magnetic flux through the interior 198 of flowtube 108.

FIGS. 3B and 3C further illustrate a split pole configuration. As illustrated in FIGS. 3A and 3B, upper pole pieces 202A and 202B include a split 240 in central portion 240. Similarly, lower pole pieces 208 includes a split 242. The split pole configuration provided by split 240 and 242 reduce the amount of eddy currents flowing through the metallic pole pieces 202 and 206. This improves the electrical parameters presented to coil driver circuitry 130 (see FIG. 2) which applies the electrical current to coil 122. Further, eddy currents in upper pole 202 are reduced by providing a stacked configuration using two, or more, pieces 202A and 202B.

In this configuration, the upper pole 202 wraps around the flowtube 108 and legs, or return paths, 230 contact each other while providing room for electrodes 124. Further, the upper pole 202 contacts the lower pole 208 through the center 238 of the coil 122 using central portions 232. With this configuration, the magnetic field produced by coil 122 is evenly distributed through the interiors 198 of flowtube 108. This helps provide a more accurate measurement of flow rate. Further, the magnetic field is “returned” to coil 122 efficiently around the exterior of flowtube 108 though return paths 230 and central portion 232.

The configuration of the present invention as illustrated in FIGS. 3A-C and 4 provides a number of advantageous characteristics. The configurations of the invention can be adjusted based upon the diameter of the process piping and the flowtube of the flowmeter. For smaller flowtubes, having a line size of less than 1.25 inch diameter, the following characteristics are provided:
1. The design provides modularity. The same magnetic component configurations can be used in multiple line sizes (magnetic coil, upper and lower poles, and polymer former/support).
2. The flat form winding configuration of coil 122 with a high packing factor (density) of magnetic wire increases magnetic efficiency.
3. The flat form winding of coil 122 is cost-effective to produce and reduces assembly time.
4. Upper and lower pole clearance is provided to both locate the electrode wire and allow the coil wire routing to optimize the frequency-response under the magnetic returns/magnetic poles.
5. The lower pole width and length can be adjusted to optimize the magnetic field distribution, inductance and signal production independently of the magnetic coil.
6. High permeability magnetic silicone steel can be used in the pole pieces to increase efficiency.
7. Layered/nonconductive coated high resistance silicone steel can be used in the pole pieces to minimize eddy current formation.
8. The layered silicone steel cross-sectional area of the upper pole pieces can be optimized to provide maximum magnetic permeability (efficiency) at a desired operating point.
9. High performance silicone steel (magnetic steel) with an optimized BH curve can be used for the upper and lower pole pieces to increase operating speed/minimize transition time of the applied field.
10. The upper pole is configured with an integral magnetic return path, as opposed to requiring a separate piece to provide the return.
11. The upper pole can be placed in close proximity (within 1.5 mm, for example) of the vertical wall of the magnetic coil. This provides 5-10% increase in signal production.
12. The magnetic return can be shaped to clear multiple electrode configurations. For example, electrode configurations for standard or high pressure flowtubes, electrodes located outside of the process seal, and other designs.
13. The magnetic field is distributed and optimized in the XY plane (electrode plane) for signal-to-noise ratio, upstream piping diameter, copper usage, and magnetic efficiency.
14. The coil winding shape (width of internal hole configuration, height, and length) can be optimized to maximize flux transfer and minimize inductance to maximize magnetic field transition speed.
15. Typical prior art configurations used the flow tube housing to conduct the magnetic field. With the present invention, a self-contained magnetics configuration is provided which can be used to minimize magnetic field fringing, allow the use of different magnetic permeable flange and housing materials, and minimize eddy currents in adjacent flange or housing materials.

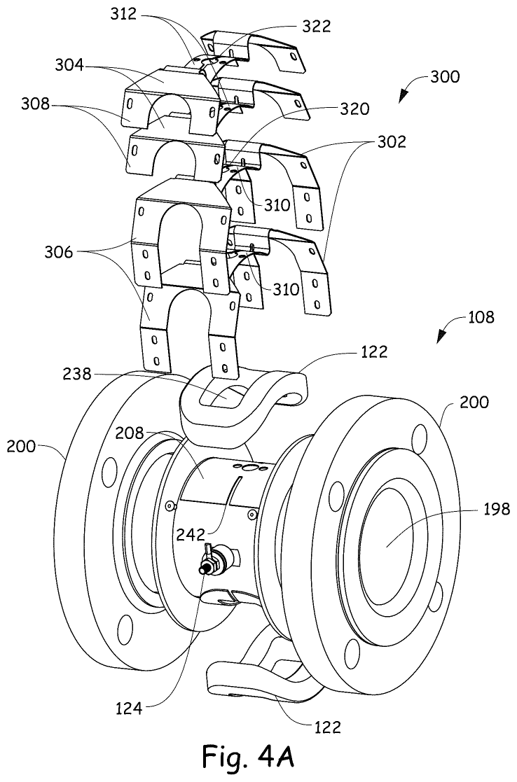

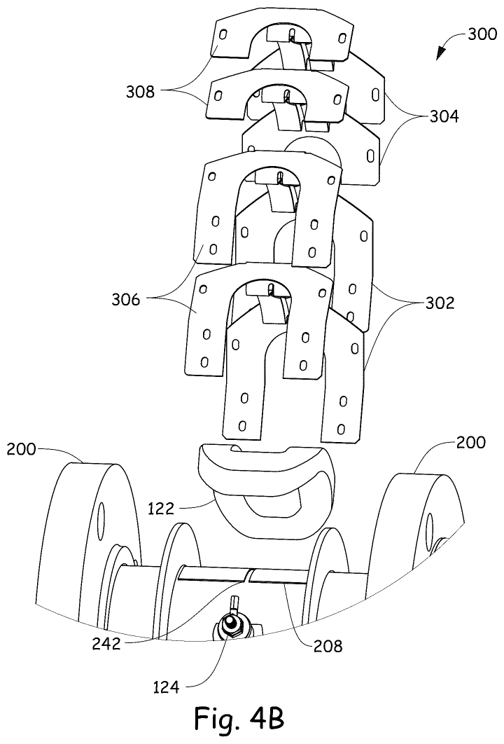

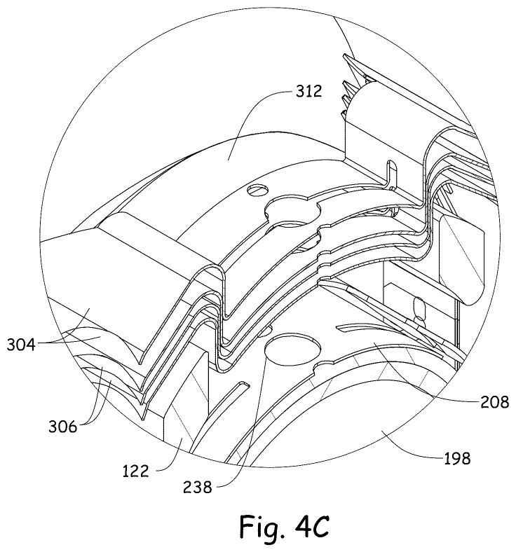

FIG. 4A is a perspective exploded view of another example configuration of a magnetic flowtube and associated magnetic components in accordance with the present invention. FIGS. 4B and 4C are enlarged perspective views of the configuration of FIG. 4A The configuration of FIGS. 4A-C is suited for larger flowtubes, for example, those having a diameter of more than 1.5 inches. Elements from the configuration shown in FIGS. 3A-C which are similar have been retained the same number in FIGS. A-C.

In the configuration shown in FIGS. 4A-C, an upper pole assembly 300 includes a plurality of individual pole pieces 302 and 304. In this configuration, pole pieces 302 are full or complete pole pieces, whereas pole pieces 304 are partial pole pieces.

Full pole pieces 302 form a “U” shape which extends around the flowtube 108. Legs or return paths, 306 are coupled together by a center portion 312 to form the “U” shape. Legs 306 extend around the exterior of the flowtube 108 and include a cutout region which extends around electrode connections 124. The upper pole assembly 300 meshes with an opposed upper pole assembly (not shown in FIG. 5) such that the two assemblies completely surround the flowtube.

The upper pole assembly 300 includes partial pole pieces 304. These partial pole pieces 304 also include legs, (or return paths) 308 on opposed sides of a central portion 312. However, the legs 308 are shorter than legs 306 of full pole pieces 302 and only extend partially around the circumference of the flowtube 108. The legs 308 also include a “U” shaped cutout region for providing clearance with respect to the electrode connection 124. The partial pole assemblies 304 form a “U” shape between legs 308 and central portions 312.

As illustrated in FIGS. 4B and 4C, the center portions 310 and 312 of pole pieces 302 and 304 extend in a downward direction such that they fit within the center 238 of coil 122. The center portions 310 and 312 magnetically couple to lower pole piece 208.

The center portions 310 and 312 of pole pieces 302 and 304 include a split 320 and 322, respectively. Similarly, lower pole piece 208 includes a split 242. As discussed previously, the split 320, 322 and 242 reduce the amount of the Eddy currents which flow within the various pole pieces and thereby improve performance of the device. Additionally, the individual pole pieces 208, 302 and 304 have an electrically insulating coating or other means such that the individual pole pieces are prevented from electrically contacting each other. This also reduces the Eddy currents in the pole pieces.

These configurations provide a self-contained magnetic component configuration with an optimized design in the X-Z plane, which minimizes magnetic fringing and allows the use of different magnetic permeable flange and housing materials. Further, the configuration reduces eddy currents in adjacent flange or housing materials.

The integral magnetic pole/magnetic return can be used for multiple electrode magnetic flowmeters which use a variety of electrode configurations for different types of sealing of the electrode. Typical prior art designs do not provide sufficient clearance through the magnetic return components for the electrode tunnels or the electrode housings required to support some designs.

The shape of the magnetic field can be adjusted independently from the coil dimensions by use of the lower pole. It is desirable to have one coil size with the same dimensions for different line sizes or products. Changing the ferromagnetic material dimensions of the lower pole allows the magnetic field to be applied across the process differently without changing the coil structure or geometry.

The split upper and lower magnetic pole design decreases artifacts of the changing magnetic B field, this includes reducing eddy currents. Further, this reduces the secondary coupling of both eddy currents and non-orthogonal magnetic fields.

Near field coupling of the inner walls of the coil to the upper pole increases the efficiency of the device. The use of deep-drawn upper poles which extend into the center of the coil and are parallel to the coil structure increases efficiency (signal strength) 5 to 10%, and also acts to mechanically secure the coil assembly to the pipe in a robust manner.

The configuration provides the same signal strength with four times less inductance than other configurations. This is an important feature that both reduces the amount of power and voltage needed to drive the coil. This minimizes the number and length of turns of magnet wire used in the coil by optimizing the lower pole and upper pole separately. With the reduced voltage, in some configurations, it may be possible to provide a device which meets intrinsic safety standards.

Further, with the improved magnetic field shape proved by this design, the accuracy of flow measurements with the flowmeter is less susceptible to turbulence in the fluid flow, for example caused by upstream angles or other variations in the piping configuration.

The invention measures the velocity of conductive fluid through a pipe or conduit, commonly referred to as an electromagnetic flowmeter, or magmeter. The advantages of this invention include:
Low power: the invention can operate significantly less power than prior designs.
Modularity: the invention can be used across multiple design configurations, line sizes, and multiple applications.
Ease of installation: the invention can be installed easily in any part of a plant, including hazardous rated areas.
High Efficiency: the signal strength produced is the same as or higher than devices using more power.
High Signal to Noise Ratio (SNR): the quality of the signal produced by the invention is significantly higher than similar devices.
Enhanced Frequency Response: this enables the device to operate at much higher frequencies with both higher signal fidelity and linearity, while requiring substantially lower power.
Flow performance: the invention provides a stable, precise signal even with a noisy process caused by disturbances in the flow of process fluid.
Ease of mounting: the configuration does not require long straight piping lengths in order to obtain accurate flow measurements.

Although the present invention has been described with reference to preferred embodiments, workers skilled in the art will recognize that changes may be made in form and detail without departing from the spirit and scope of the invention. As illustrated in the Figures, the magnetic pole pieces have a general “U” shape which extends at least partially around an outer circumference of the flowtube. The upper magnetic pole includes cut out regions which are also formed of a “U” shape and arranged to fit around the electrode of the flowmeter. The new pole configurations provide a highly efficient magnetic flowmeter which is capable of operating at higher frequencies than typical prior art configurations.

What is claimed is:

1. A magnetic flowmeter for measuring flow rate of a process fluid, comprising:
a flowtube arranged to receive a flow of the process fluid therethrough;
a first magnetic coil arranged proximate the flowtube to apply a magnetic field to the process fluid flowing through the flowtube;
a pair of electrodes electrically coupled to the process fluid in the flowtube and arranged to sense a voltage induced in the process fluid related to the applied magnetic field and a flow rate of the process fluid;
flowmeter circuitry configured to apply an electric current to the first magnetic coil and receive the voltage sensed by the pair of electrodes; and
an upper magnetic pole adjacent the first magnetic coil arranged to direct the magnetic field into the process fluid flowing through the flowtube, wherein the upper magnetic pole has a split configuration.

2. The magnetic flowmeter of claim 1 wherein the upper magnetic pole is formed of at least two separate pole pieces.

3. The magnetic flowmeter of claim 2 wherein the at least two separate pole pieces are arranged in a stacked configuration.

4. The magnetic flowmeter of claim 2 wherein the at least two separate pole pieces are electrically insulated from each other.

5. The magnetic flowmeter of claim 1 wherein the upper magnetic pole has a U-shape which extends at least partially around the flowtube.

6. The magnetic flowmeter of claim 1 wherein the upper magnetic pole includes cut out regions arranged to fit around the pair of electrodes.

7. The magnetic flowmeter of claim 1 wherein the upper magnetic pole includes two magnetic return portions and a center portion which extends therebetween.

8. The magnetic flowmeter of claim 7 wherein the first magnetic coil includes an open center region and the center portion of the upper magnetic pole is arranged to extend into the open region.

9. The magnetic flowmeter of claim 8 including a lower magnetic pole adjacent the flowtube and the first magnetic coil is positioned between the upper magnetic pole and the lower magnetic pole, wherein the center portion of the upper magnetic pole magnetically couples to the lower magnetic pole.

10. The magnetic flowmeter of claim 7 wherein the split configuration comprises a slit formed in the center portion.

11. The magnetic flowmeter of claim 10 wherein the slit comprises a slot in the center portion which extends in a circumferential direction around the flowtube.

12. The magnetic flowmeter of claim 1 including a second magnetic coil positioned adjacent the flowtube opposite the first magnetic coil and a second upper magnetic pole adjacent the second magnetic coil.

13. The magnetic flowmeter of claim 1 including a lower magnetic pole adjacent the flowtube and wherein the first magnetic coil is positioned between the upper magnetic pole and the lower magnetic pole and the lower magnetic pole is configured to direct a magnetic field generated by the first magnetic coil into the process fluid flowing through the flowtube.

14. The magnetic flowmeter of claim 13 wherein the lower magnetic pole has a split configuration comprising a slot which extends in a circumferential direction around the flowtube.

15. The magnetic flowmeter of claim 1 wherein the upper magnetic pole comprises a full magnetic pole piece and a partial magnetic pole piece, wherein the partial magnetic pole piece spans a portion of a circumference of the flowtube which is less than a portion of the circumference spanned by the full magnetic pole piece.

16. The magnetic flowmeter of claim 15 wherein the partial magnetic pole piece and the full magnetic pole piece include cut out regions adapted to fit around the pair of electrodes.

17. A magnetic flowmeter for measuring flow rate of a process fluid, comprising:
a flowtube arranged to receive a flow of the process fluid therethrough;
a first magnetic coil arranged proximate the flowtube to apply a magnetic field to the process fluid flowing through the flowtube;
a pair of electrodes electrically coupled to the process fluid in the flowtube and arranged to sense a voltage induced in the process fluid related to the applied magnetic field and a flow rate of the process fluid;
flowmeter circuitry configured to apply an electric current to the first magnetic coil and receive the voltage sensed by the pair of electrodes; and
an upper magnetic pole adjacent the first magnetic coil arranged to direct the magnetic field into the process fluid flowing through the flowtube, wherein the upper magnetic pole is formed by at least two pole pieces.

18. The magnetic flowmeter of claim 17 wherein the at least two pole pieces are electrically insulated from each other.

19. The magnetic flowmeter of claim 17 wherein the upper magnetic pole has a U-shape which extends at least partially around the flowtube.

20. The magnetic flowmeter of claim 17 wherein the upper magnetic pole includes two magnetic return portions and a center portion which extends therebetween and the first magnetic coil includes an open center region and the center portion of the upper magnetic pole is arranged to extend into the open region.

21. The magnetic flowmeter of claim 20 wherein the upper magnetic pole has a split configuration comprising a slit formed in the center portion.

22. The magnetic flowmeter of claim 17 wherein the upper magnetic pole comprises a full magnetic pole piece and a partial magnetic pole piece, wherein the partial magnetic pole piece spans a portion of a circumference of the flowtube which is less than a portion of the circumference spanned by the full pole piece.

23. The magnetic flowmeter of claim 22 wherein the full magnetic pole piece and the partial magnetic pole piece each comprise at least two sections arranged in a stacked configuration.
